(19) United States
(12) Patent Application Publication
(10) Pub. No.: US 2013/0069368 A1
(43) Pub. Date: Mar. 21, 2013

(54) WAVE POWER GENERATING APPARATUS AND METHOD

(71) Applicants: Jin Bae PARK, Goyang-si (KR); Jae Man KIM, Seoul (KR); Hwa Chang SUNG, Seoul (KR); Min Kook SONG, Seoul (KR); Geun Bum KOO, Daegu (KR); Seung Kwan SONG, Seoul (KR)

(72) Inventors: Jin Bae PARK, Goyang-si (KR); Jae Man KIM, Seoul (KR); Hwa Chang SUNG, Seoul (KR); Min Kook SONG, Seoul (KR); Geun Bum KOO, Daegu (KR); Seung Kwan SONG, Seoul (KR)

(73) Assignee: Industry-Academic Cooperation Foundation, Yonsei University, Seoul (KR)

(21) Appl. No.: 13/425,132

(22) Filed: Mar. 20, 2012

(30) Foreign Application Priority Data
Sep. 15, 2011 (KR) 10-2011-0092987

(51) Int. Cl. F03B 13/12

(52) U.S. Cl. 290/53

(57) ABSTRACT

Provided is a wave power generating apparatus and method. According to an aspect of the present invention, there is provided a wave power generating apparatus comprising: a housing; a bellows shaped like a corrugated hose having an open end, disposed in the housing, and extended or contracted by an external force; a weight disposed on the bellows; a rotor disposed on the weight and moving according to the extension or contraction of the bellows and the movement of the weight; and a generator converting kinetic energy of the rotor into electric energy.

### CROSS-REFERENCE TO RELATED APPLICATIONS

This application claims priority from Korean Patent Application No. 10-2011-0092987 filed on Sep. 15, 2011 in the Korean Intellectual Property Office, the disclosure of which is incorporated herein by reference in its entirety.

### BACKGROUND OF THE INVENTION

1. Field of the Invention

The present invention relates to a wave power generating apparatus and method, and more particularly, to a wave power generating apparatus structured to float underwater and generate wave power efficiently and a wave power generating method used by the wave power generating apparatus.

2. Description of the Related Art

Power generation using seawater is gaining popularity as a future environment-friendly energy generation method since it uses energy available in nature, do not require a great installation cost, and is safe.

There are various types of power generation using seawater, for example: ocean current power generation that uses the flow of water in a direction, tidal power generation that uses the difference between high and low tides, and wave power generation that uses a short-term rise and fall of the sea surface caused by waves or a swell.

In particular, wave power generation is to convert the periodic up-and-down motion of the sea surface or the back-and-forth motion of water particles caused by waves into mechanical kinetic energy and then into electric energy using an energy converter.

Most conventional wave power generators are installed on the surface of the sea. Therefore, they are highly likely to be damaged or lost by natural disasters such as high seas and tsunami. Furthermore, Korean coasts have a relatively low wave height. For example, the east coast of Korea has an average wave height of 1.2 to 1.5 m/s which is lower than 2.5 m/s for the coasts of Europe which has been conducting substantive research on wave power generation.

Since wave power generation is based on the up-and-down motion of waves, the wave height greatly affects the amount of power generated. Therefore, wave power generators installed on the sea surface are not effective in Korean waters which have a relatively low wave height.

For example, referring to a wave power generator disclosed in International Patent Publication No. WO 2008/149084 on Dec. 11, 2008, the pressure inside the wave power generator should be relatively high in order to balance the sum of seawater pressure and the pressure caused by the weight of a lid (a cap on the generator). In addition, since a change in wave height results in a small change in the internal volume of the wave power generator, the change in the amplitude of a linear rotor with respect to the amplitude of the wave height is small.

### SUMMARY OF THE INVENTION

Aspects of the present invention provide a wave power generating apparatus which can be installed underwater and thus protected from natural disasters such as high seas and tsunami, and a wave power generating method used by the wave power generating apparatus.

Aspects of the present invention also provide a wave power generating apparatus whose inside is completely protected from seawater by a bellows, etc. made of a waterproof material and which can easily control internal pressure, and a wave power generating method used by the wave power generating apparatus.

Aspects of the present invention also provide a wave power generating apparatus which can be installed in waters having a low wave height like Korean waters since a large change can be induced in the internal volume of the wave power generating apparatus with respect to the change in wave height while the pressure inside the wave power generating apparatus is maintained relatively low and the change in the amplitude of a rotor of the wave power generating apparatus with respect to the amplitude of the wave height can be increased to generate a large amount of power with respect to the wave height, and a wave power generating method used by the wave power generating method.

Aspects of the present invention also provide a wave power generating apparatus which has a simple internal structure, is easy to maintain since internal structures can be completely protected from seawater by a bellows, etc. made of a waterproof material, and can float underwater since seawater pressure acts on a body of the wave power generating apparatus in a vertically upward direction, and a wave power generating method used by the wave power generating apparatus.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided a wave power generating apparatus comprising: a housing; a bellows shaped like a corrugated hose having an open end, disposed in the housing, and extended or contracted by an external force; a weight disposed on the bellows; a rotor disposed on the weight and moving according to the extension or contraction of the bellows and the movement of the weight; and a generator converting kinetic energy of the rotor into electric energy.

According to another aspect of the present invention, there is provided a wave power generating apparatus comprising: a body in which various assemblies for wave power generation are installed; a driving assembly disposed in the body, comprising an internal space which has an open end and a closed end, and extended or contracted by the inflow or outflow of seawater into or from the internal space; a guide assembly connected to an upper end of the driving assembly, moving according to the extension or contraction of the driving assembly, and controlling a balance between pressure inside the body and seawater pressure inside the driving assembly; and a generating assembly converting kinetic energy generated by the movement of the guide assembly into electric energy.

According to another aspect of the present invention, there is provided a wave power generating method used by a wave power generating apparatus which comprises a housing, a bellows installed in the housing and shaped like a corrugated hose, a weight disposed on the bellows, a rotor disposed on the weight and making an up-and-down motion, and a generator converting kinetic energy of the rotor into electric energy, the method comprising: seawater flowing into or out of the bellows through an open end of the bellows; the bellows being extended or contracted by the inflow or outflow of the seawater; the weight ascending or descending according to the extension or contraction of the bellows; the rotor ascending or descending according to the ascending or descending of the weight; and the generator generating electricity as the rotor ascends or descends.

### BRIEF DESCRIPTION OF THE DRAWINGS

The above and other aspects and features of the present invention will become more apparent by describing in detail exemplary embodiments thereof with reference to the attached drawings, in which:

FIGS. 1A and 1B are cross-sectional views of a wave power generating apparatus according to an embodiment of the present invention;

FIG. 2 is a perspective view of the wave power generating apparatus according to the embodiment of FIG. 1;

FIG. 3 is a bottom view of the wave power generating apparatus according to the embodiment of FIG. 1;

FIG. 4 is a cross-sectional view of a wave power generating apparatus according to another embodiment of the present invention;

FIG. 5 is a perspective view of a driving assembly of the wave power generating apparatus according to the embodiment of FIG. 4;

FIG. 6 is a cross-sectional view of a guide assembly of the wave power generating apparatus according to the embodiment of FIG. 4;

FIG. 7 is a cross-sectional view of a first embodiment of a generating assembly included in the wave power generating apparatus according to the embodiment of FIG. 4;

FIG. 8 is a cross-sectional view of a second embodiment of the generating assembly included in the wave power generating apparatus according to the embodiment of FIG. 4;

FIG. 9 is a flowchart illustrating a wave power generating method according to an embodiment of the present invention; and

FIG. 10 is a flowchart illustrating a wave power generating method according to another embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. The same reference numbers indicate the same components throughout the specification. In the attached figures, the thickness of layers and regions is exaggerated for clarity.

Unless defined otherwise, all technical and scientific terms used herein have the same meaning as commonly understood by one of ordinary skill in the art to which this invention belongs. It is noted that the use of any and all examples, or exemplary terms provided herein is intended merely to better illuminate the invention and is not a limitation on the scope of the invention unless otherwise specified. Further, unless defined otherwise, all terms defined in generally used dictionaries may not be overly interpreted.

Hereinafter, the present invention will be described in more detail with reference to the attached drawings.

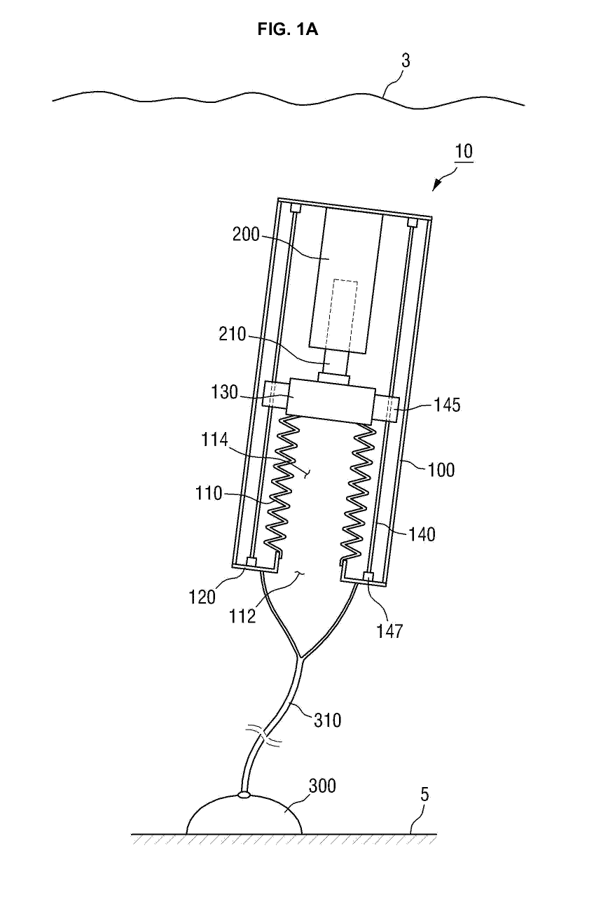

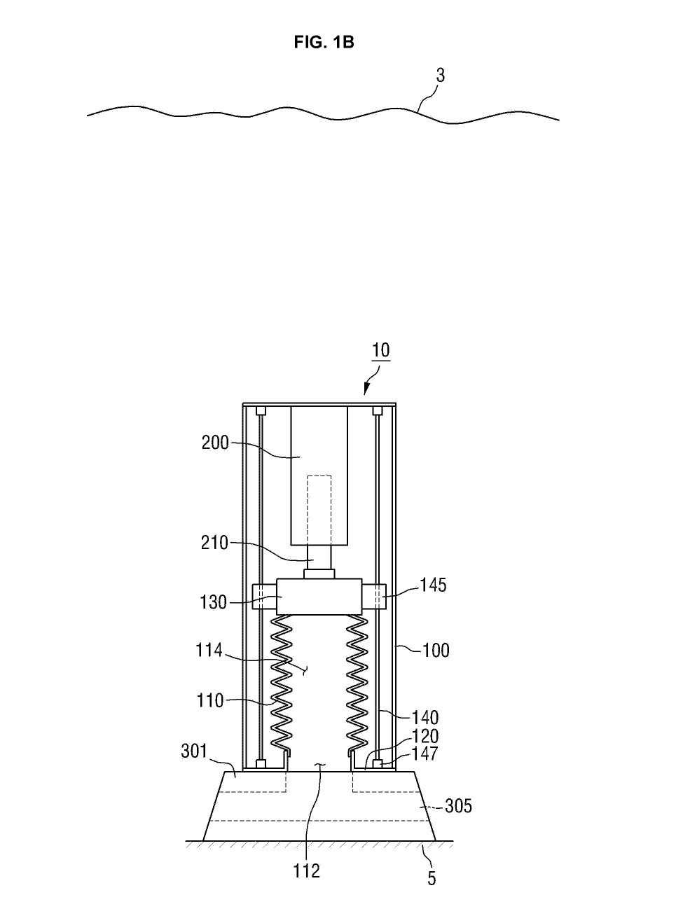

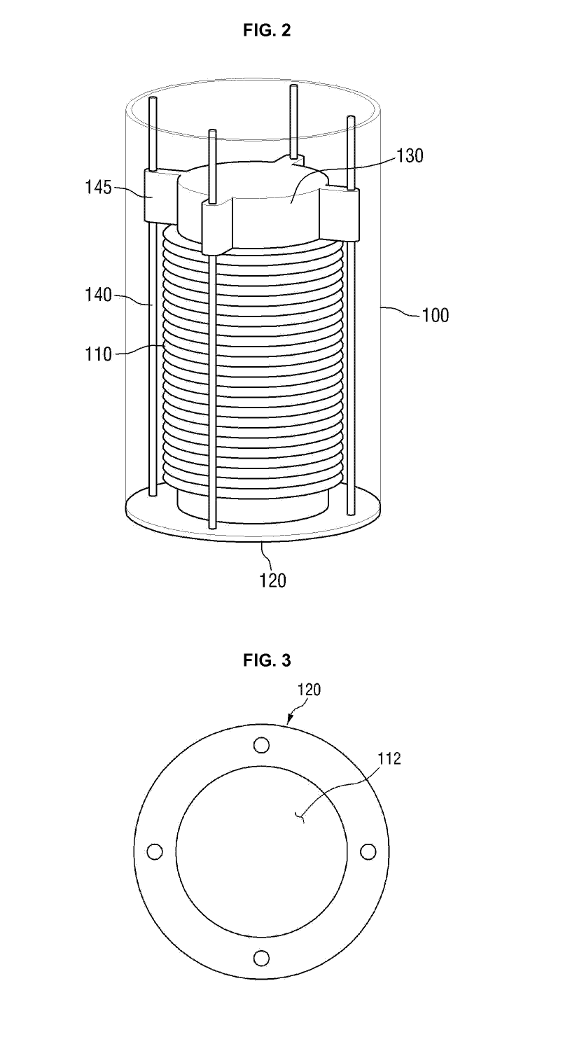

FIGS. 1A and 1B are cross-sectional views of a wave power generating apparatus 10 according to an embodiment of the present invention. FIG. 2 is a perspective view of the wave power generating apparatus 10 according to the embodiment of FIG. 1. FIG. 3 is a bottom view of the wave power generating apparatus 10 according to the embodiment of FIG. 1.

The wave power generating apparatus 10 according to the current embodiment includes a housing 100, a bellows 110, a weight 130, a rotor 210, and a generator 200. The wave power generating apparatus 10 further includes a flange 120, a plurality of linear guide shafts 140, a linear guide block 145, a plurality of shaft supports 147, a first support 300, and a rope 310.

The housing 100 forms the exterior of the wave power generating apparatus 10. The bellows 110, the weight 130, the linear guide shaft 140, etc are disposed within the housing 100. The housing 100 may be made of a material that can withstand underwater pressure, such as metal or reinforced plastic. The surface of the housing 100 is waterproofed in order to prevent seawater from entering the housing 100.

The bellows 110 is shaped like a corrugated hose with an open end. That is, the bellows 110 is shaped like a bellows hose. The bellows 110 is disposed within the housing 100 and is extended or contracted by an external force. In addition, the bellows 110 includes a cavity 114 therein, and seawater flows into the cavity 114 through the open end. The open end serves as an inlet/outlet 112 through which seawater flows into or out of the cavity 114.

Like a foldable bucket having a bellows shape, the bellows 110 is vertically extended or contracted by the inflow or outflow of seawater. Specifically, when seawater enters the cavity 114, the bellows 110 is extended. Conversely, when seawater flows out of the cavity 114 through the inlet/outlet 112, the bellows 110 is contracted. The flow of seawater into or out of the cavity 114 of the bellows 110 results from a change in water pressure according to a wave height 3 of the seawater.

In order to prevent seawater flowing into the cavity 114 of the bellows 110 from permeating into the housing 100, the bellows 110 may be made of a waterproof material. For example, the bellows 110 may be made of a material such as plastic, natural rubber, or automobile tire. In this case, seawater flowing into the cavity 114 of the bellows 110 can be prevented from permeating into the housing 100.

The bellows 110 is installed inside the housing 100 and connected to the housing 100 by the flange 120. In addition, the flange 120 prevents seawater from flowing into the housing 100. In FIG. 3, the flange 120 and the seawater inlet/outlet 112 formed at the open end of the bellows 110 are illustrated.

The weight 130 is disposed on the bellows 110. While an end of the bellows 110 is open to accommodate seawater and thus has the inlet/outlet 112, the other end of the bellows 110 is sealed to prevent the permeation of the seawater. The weight 130 may weigh an amount that strikes a balance between the pressure inside the housing 100 and external pressure caused by seawater. As the bellows 110 is repeatedly and periodically extended and contracted according to the wave cycle, the weight 130 moves up and down accordingly.

The wave power generating apparatus 10 includes a number of elements for guiding the movement of the weight 130 according to the extension or contraction of the bellows 110. The wave power generating apparatus 10 further includes the linear guide shafts 140 which are fixed to both inner sides of the housing 100 and the linear guide block 145 which is connected to the weight 130 and moves along the linear guide shafts 140. The wave power generating apparatus 10 further includes the shaft supports 147 which fix the linear guide shafts 140 to the inside of the housing 100.

Referring to FIGS. 1A and 1B, when seawater flows into the cavity 114 of the bellows 110, the water pressure inside the bellows 110 increases, and the increased water pressure extends the bellows 110. Accordingly, the weight 130 connected to the linear guide block 145 moves upward along the linear guide shafts 145. Conversely, when seawater flows out of the cavity 114 of the bellows 110, the bellows 110 is contracted. Accordingly, the weight 130 connected to the linear guide block 145 moves downward along the linear guide shafts 145.

The linear guide shafts 140 are fixed to the housing 100 by the shaft supports 147, and the linear guide block 145 connected to the weight 130 moves along the linear guide shafts 145. Thus, the bellows 110 can be vertically extended or contracted within the housing 100.

The rotor 210 is disposed on the weight 130 and moves in accordance with the extension or contraction of the bellows 110 and the movement of the weight 130. The rotor 210 serves as a source of kinetic energy which is converted into electric energy.

The generator 200 converts kinetic energy of the rotor 210 into electric energy. For example, the rotor 210 may be formed as a permanent magnet. In this case, whenever the rotor 210 moves up and down inside the generator 200, a coil inside the generator 200 may produce an induced electromotive force, thereby generating electricity.

Alternatively, a coil may be wound around the rotor 210, and a plurality of permanent magnets may be installed within the generator 200 such that N and S poles are arranged alternately. In this case, the generator 200 may generate electric energy from the movement of the rotor 210. The rotor 210 and the generator 200 installed in an upper part of the housing 100 seal the upper part of the housing 100.

The wave power generating apparatus 10 requires fixing members that make the housing 100 float underwater or fix the housing 100 to a seabed 5. In FIG. 1A, the housing 100 is made to float underwater. In FIG. 1B, the housing 100 is fixed to the seabed 5.

Referring to FIG. 1A, the wave power generating apparatus 10 further includes the first support 300 which is fixed to the seabed 5 and the rope 310 which connects the first support 300 and the housing 100. The housing 100 can be installed in a shallow sea or in coastal waters by the first support 300 and the rope 310. The rope 310 allows the housing 100 to move freely underwater according to the flow of seawater.

That is, the hosing 100 can float freely underwater. Under the sea, the housing 100 and the bellows 110, the weight 130, etc inside the housing 100 shown in FIG. 2 are connected and fixed to the first support 300 by the rope 310. The rope 310 may be made of a material that can fully withstand the buoyancy of the housing 100, such as iron core wire or nylon. Since the housing 100 can float freely underwater, a steel-frame structure for fixing the housing 100 to the seabed 5 is not required, thus reducing the installation cost.

Referring to FIG. 1B, the wave power generating apparatus 10 further includes a second support 301 which is installed on the seabed 5 to support the housing 100 and includes a seawater induction passage 305 through which seawater flows. Through the seawater induction passage 305, seawater flows into or out of the bellows 110 inside the housing 100. The housing 100 is supported by the second support 301 installed on the seabed 5. Thus, the housing 100 does not float underwater but is fixed to the seabed 5. In this case, the rope 310 is not required, and a simple structure, i.e., the second support 305 including the seawater induction passage 305 is used instead of a complicated structure. This simplifies installation and reduces costs.

Referring to FIG. 2, the housing 100 is coupled to the bellows 110 therein by the flange 120 and includes the linear guide block 145 and the linear guide shafts for the extension or contraction of the bellows 110 and the linear motion of the weight 130. Therefore, it can be understood that the wave power generating apparatus 10 has a very simple internal structure. In addition, since the flow of seawater into the housing 100 is completely blocked by the bellows 110 and the flange 120, structures inside the housing 100 can be protected. The simple internal structure of the wave power generating apparatus 10 makes maintenance easy.

The wave power generating apparatus 10 shown in FIGS. 1A through 2 operates as follows. When waves are calm, the sum of atmospheric pressure and water pressure which corresponds to an installation depth of the housing 100 acts on a bottom surface of a top plate of the bellows 110, and the internal atmospheric pressure of the housing 100 and the pressure of the weight 130 act on a top surface of the top plate of the bellows 110. The internal atmospheric pressure and the mass of the weight 130 are determined such that the pressures acting on the top and bottom surfaces of the top plate of the bellows 110 are offset. Here, the position of the bellows 110 is an equilibrium point of oscillation of the rotor 210. In addition, a buoyant force acting on the entire wave power generating apparatus 10 in a vertically upward direction is greater than the total weight of the wave power generating apparatus 10 including the weight 130. This buoyancy enables the wave power generating apparatus 10 to float in water.

As the wave height 3 increases, the water pressure outside the housing 100 increases. Accordingly, seawater flows into the bellows 110 through the seawater inlet/outlet 112, thus increasing the water pressure inside the bellows 110. The increased water pressure extends the bellows 110, which, in turn, causes the weight 130 connected to the upper end of the bellows 110 to move upward. As the weight 130 moves upward, the rotor 210 connected to an upper end of the weight 130 also moves upward within the generator 200.

As the wave height 3 decreases, the water pressure outside the housing 100 decreases. Accordingly, the water pressure inside the bellows 110 is reduced, and the reduced water pressure contracts the bellows 110. As the bellows 110 contracts, the weight 130 connected to the upper end of the bellows 110 moves downward, and the rotor 210 connected to the weight 130 also moves downward within the generator 200.

As the wave height 3 increases and decreases repeatedly, the bellows 110 is extended and contracted repeatedly, and the weight 130 moves up and down repeatedly. Accordingly, the rotor 210 also moves up and down repeatedly within the generator 200. As a result, electric energy can be obtained from the generator 200. Electricity generated by the generator 200 may be stored in a storage device such as a capacitor or may be transferred to land through an undersea cable.

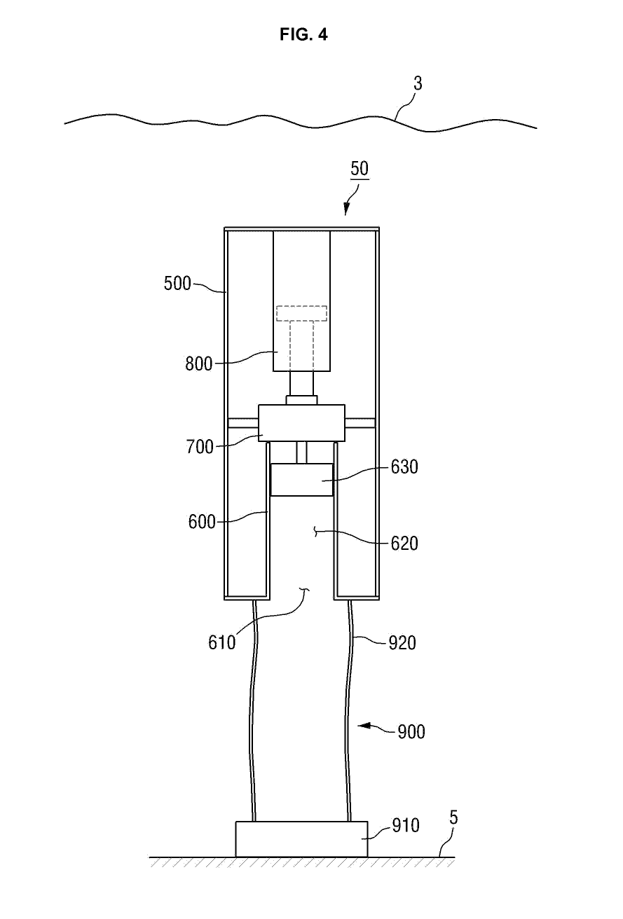

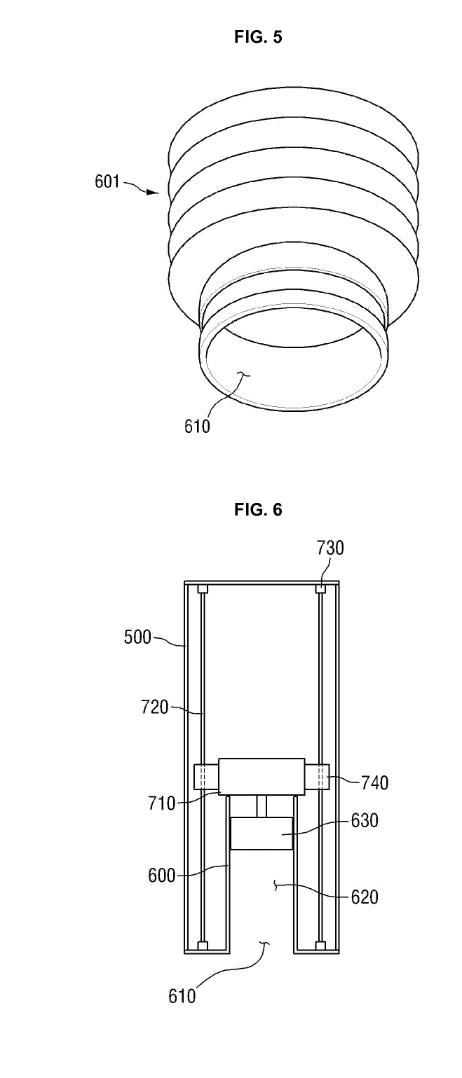

FIG. 4 is a cross-sectional view of a wave power generating apparatus 50 according to another embodiment of the present invention. FIG. 5 is a perspective view of a driving assembly of the wave power generating apparatus 50 according to the embodiment of FIG. 4. FIG. 6 is a cross-sectional view of a guide assembly 700 of the wave power generating apparatus 50 according to the embodiment of FIG. 4.

The wave power generating apparatus 50 according to the current embodiment includes a body 500, a driving assembly 600, the guide assembly 700, and a generating assembly 800. The wave power generating apparatus 50 may further include a fixing assembly 900.

A plurality of assemblies are installed inside the body 500 and prevent seawater from entering the body 500. The body 500 may have various shapes such as a cylinder and a polygonal prism. However, the body 500 may preferably have a cylindrical shape to allow the assemblies to be installed therein with increased efficiency.

The driving assembly 600 includes a driving piston 630 which is moved up or down by the inflow or outflow of seawater. The driving assembly 600 is disposed within the body 500, and seawater flows into or out of an internal space 620 of the driving assembly 600. An end of the internal space 620 is open, and the other end thereof is closed. The inflow or outflow of seawater moves the piston 630 up or down, thereby moving the guide assembly 700. The open end of the driving assembly 600 severs as a seawater inlet/outlet 610.

The driving assembly 600 may be shaped like a corrugated hose having a bellows shape, such that it can be flexibly extended or contracted by the inflow or outflow of seawater. A driving assembly 601 shown in FIG. 5 is shaped like a corrugated hose, and seawater flows into or out of the driving assembly 601 through an inlet/outlet 610.

In order to prevent seawater flowing into the internal space 620 of the driving assembly 600 from permeating into the body 500, the driving assembly 600 may be made of a waterproof material. An example of a material that maximizes the extension or contraction of the driving assembly 600 and the waterproof effect of the driving assembly 600 is rubber tire. However, other materials are also applicable.

The guide assembly 700 is connected to an upper end of the driving assembly 600 and is moved by the extension or contraction of the driving assembly 600 and/or the movement of the driving piston 630 included in the driving assembly 600. The guide assembly 700 controls a balance between the pressure inside the body 500 and the seawater pressure inside the driving assembly 600. As the driving assembly 600 is extended or contracted by the inflow or outflow of seawater, the guide assembly 700 connected to the driving assembly 600 moves accordingly.

The atmospheric pressure inside the body 500 acts in a downward direction, whereas the seawater pressure inside the driving assembly 600 acts in an upward direction. Therefore, a balance between the pressure inside the body 500 and the seawater pressure inside the driving assembly 600 is achieved by the weight of the guide assembly 700. That is, a force imposed on the driving assembly 600 by the guide assembly 700 and the pressure inside the body 500 combine to balance the seawater pressure inside the driving assembly 600.

The guide assembly 700 includes a weight 710 which controls a balance between the pressure inside the body 500 and the seawater pressure inside the driving assembly 600. The weight 710 is disposed on the driving assembly 600 to strike a balance between the pressure inside the body 500 and the seawater pressure inside the driving assembly 600.

In addition, the guide assembly 700 includes a plurality of guide shafts 720 which are fixed to upper and lower ends of the body 500, a pair of shaft supports 730 which connect and fix both ends of each of the guide shafts 720 to the body 500, and a guide block 740 which is connected to the weight 710 and moves along the guide shafts 720. The weight 710 moves according to the movement of the guide block 740.

Referring to FIG. 6, when seawater flows into the internal space 620 of the driving assembly 600, the driving assembly 600 is extended. Accordingly, the weight 710 connected to the guide block 740 moves up the body 500 along the guide shafts 720. Conversely, when seawater flows out of the internal space 620 of the driving assembly 600, the driving assembly 600 is contracted. Accordingly, the weight 710 connected to the guide block 740 moves down the body 500 along the guide shafts 720. Here, the up and down movement of the weight 710 is intended to strike a balance between the sum of the pressure inside the body 500 and the weight of the weight 710 and the seawater pressure inside the driving assembly 600.

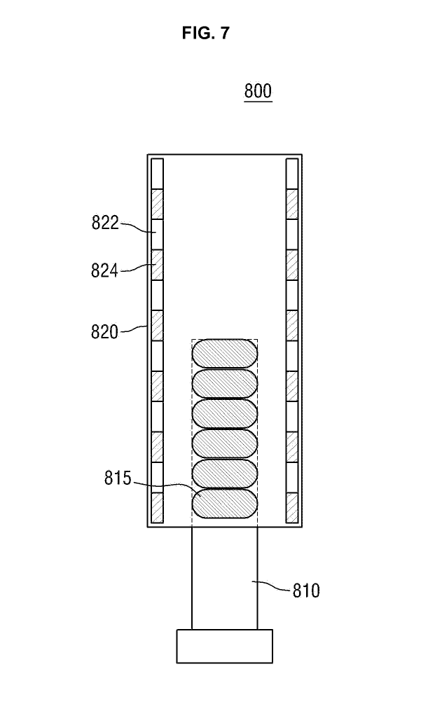

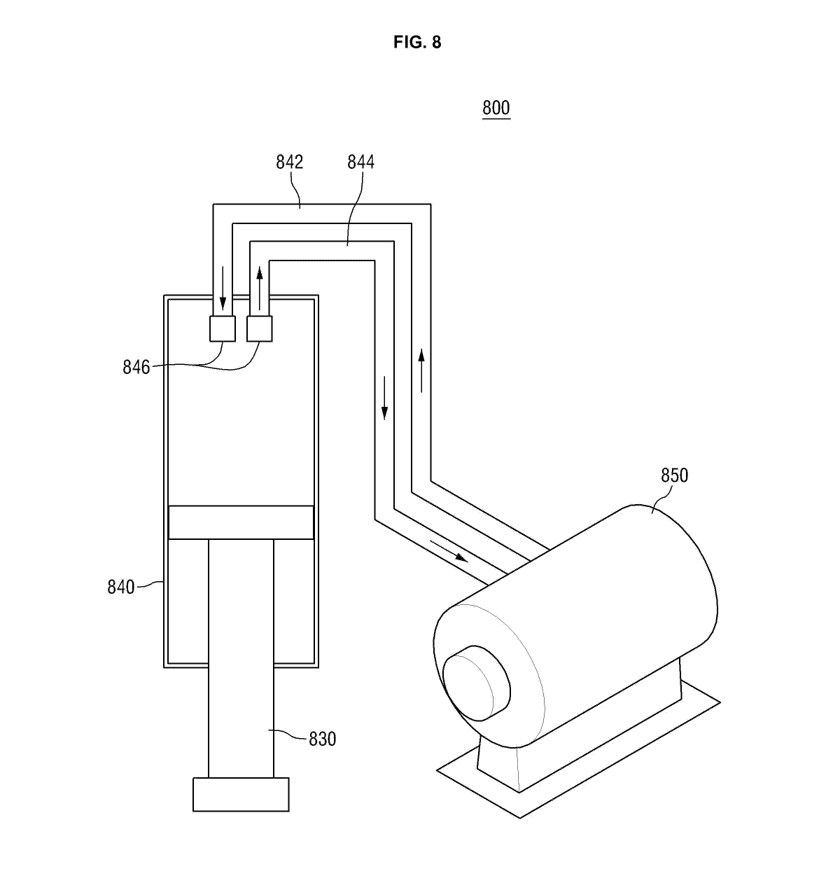

The generating assembly 800 converts kinetic energy generated by the movement of the guide assembly 700 into electric energy. A detailed configuration of the generating assembly 800 will now be described with reference to FIGS. 7 and 8.

FIG. 7 is a cross-sectional view of a first embodiment of the generating assembly 800 included in the wave power generating apparatus 50 according to the embodiment of FIG. 4. FIG. 8 is a cross-sectional view of a second embodiment of the generating assembly 800 included in the wave power generating apparatus 50 according to the embodiment of FIG. 4.

Referring to FIG. 7, the generating assembly 800 includes a rotor 810 and a stator 820. The rotor 810 is connected to an upper end of the guide assembly 700 and moves according to the movement of the guide assembly 700. The rotor 810 includes a coil 815. The stator 820 includes an internal space in which the rotor 810 moves and includes N- and S-pole magnets 822 and 824 arranged alternately.

As the rotor 810 moves up and down in the internal space of the stator 820, the coil 815 included in the rotor 810 also moves within the stator 820. Accordingly, the density of magnetic flux passing through a cross-sectional area of the coil 815 changes, thus creating an induced electromotive force. Based on this principle, the generating assembly 800 converts kinetic energy generated by the movement of the guide assembly 700 into electric energy.

The N- and S-pole magnets 822 and 824 arranged alternately in the stator 820 may be replaced by the coil 815 of the rotor 810, and the rotor 810 may be formed as a permanent magnet. In this case, whenever the rotor 810 moves up and down within the stator 820 having the coil 815 wound therearound, electricity is generated.

Referring to FIG. 8, the generating assembly 800 includes a generating piston 830, a hydraulic cylinder 840, and a hydraulic generator 850. The generating piston 830 is connected to the upper end of the guide assembly 700 and making an up-and-down motion according to the movement of the guide assembly 700. A fluid in the hydraulic cylinder 840 is circulated by the up-and-down motion of the generating piston 830, and the circulation of the fluid of the hydraulic cylinder 840 rotates a motor of the hydraulic generator 850, thereby generating electricity.

The hydraulic cylinder 840 and the hydraulic generator 850 are connected to each other by a pair of pipes 842 and 844. The fluid contained in the hydraulic cylinder 840 flows into the hydraulic generator 850 through the pipe 844 to rotate the motor of the hydraulic generator 850 and returns to the hydraulic cylinder 840 through the other pipe 842.

The hydraulic cylinder 840 includes a pair of check values 846, each allowing a fluid to flow only in one direction. The check values 846 allow fluids to flow in opposite directions. Therefore, the direction of a fluid can be set by setting each of the check values 846. That is, a fluid discharged from the hydraulic cylinder 840 flows into the hydraulic generator 850 through the outlet pipe 844 to generate electricity and then discharged from the hydraulic generator 850 to flow back into the hydraulic cylinder 840 through the inlet pipe 842. In this way, the fluid of the hydraulic cylinder 840 is circulated.

The wave power generating apparatus 50 according to the embodiment of FIG. 4 may further include the fixing assembly 900. The fixing assembly 900 further includes a support 910 and a connector 920. The support 910 is installed on a seabed 5, and the connector 920 connects the support 910 and the body 500.

The operation of the wave power generating apparatus 50 according to a wave height 3 is similar to the operation of the wave power generating apparatus 10 described above, and thus a description thereof will be omitted.

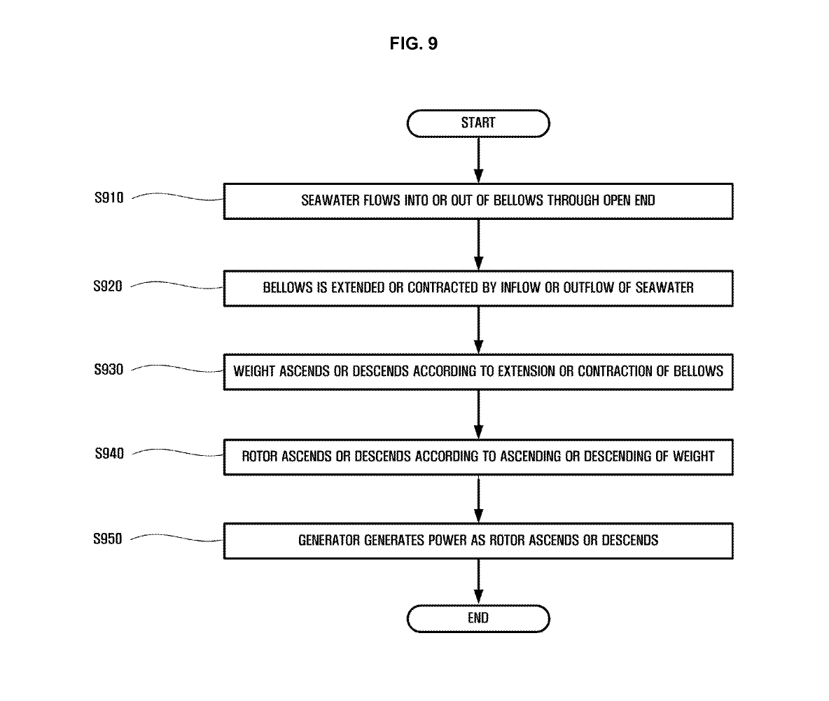

FIG. 9 is a flowchart illustrating a wave power generating method according to an embodiment of the present invention.

The wave power generating method according to the current embodiment is used by a wave power generating apparatus which includes a housing 100, a bellows 110 installed in the housing 100 and shaped like a corrugated hose, a weight 130 disposed on the bellows 110, a rotor 210 disposed on the weight 130 and making an up-and-down motion, and a generator 200 converting kinetic energy of the rotor 210 into electric energy. Specifically, seawater flows into or out of the bellows 110 through an open end of the bellows 110 (operation S910), and the bellows 110 is extended or contracted by the inflow or outflow of the seawater (operation S920). The extension or contraction of the bellows 110 raises or lowers the weight 130 (operation S930). As the weight 130 ascends or descends, the rotor 210 also ascends or descends (operation S940). As the rotor 210 ascends or descends, the generator 200 generates electricity (operation S950).

More specifically, as a wave height 3 increases, the water pressure outside the housing 100 increases. Accordingly, seawater flows into the bellows 110 through a seawater inlet/outlet 112, thus increasing the water pressure inside the bellows 110 (operation S910). The increased water pressure extends the bellows 110 (operation S920), which, in turn, causes the weight 130 connected to an upper end of the bellows 110 to move upward (operation S930). As the weight 130 moves upward, the rotor 210 connected to an upper end of the weight 130 also moves upward within the generator 200.

Conversely, as the wave height 3 decreases, the water pressure outside the housing 100 decreases. Accordingly, the water pressure inside the bellows 110 is reduced (operation S910), and the reduced water pressure contracts the bellows 110 (operation S920). As the bellows 110 contracts, the weight 130 connected to the upper end of the bellows 110 moves downward (operation S930), and the rotor 210 connected to the weight 130 also moves downward within the generator 200 (operation S940).

As the wave height 3 increases and decreases repeatedly, the bellows 110 is extended and contracted repeatedly, and the weight 130 moves up and down repeatedly. Accordingly, the rotor 210 also moves up and down repeatedly within the generator 200. As a result, electric energy can be obtained from the generator 200 (operation S950).

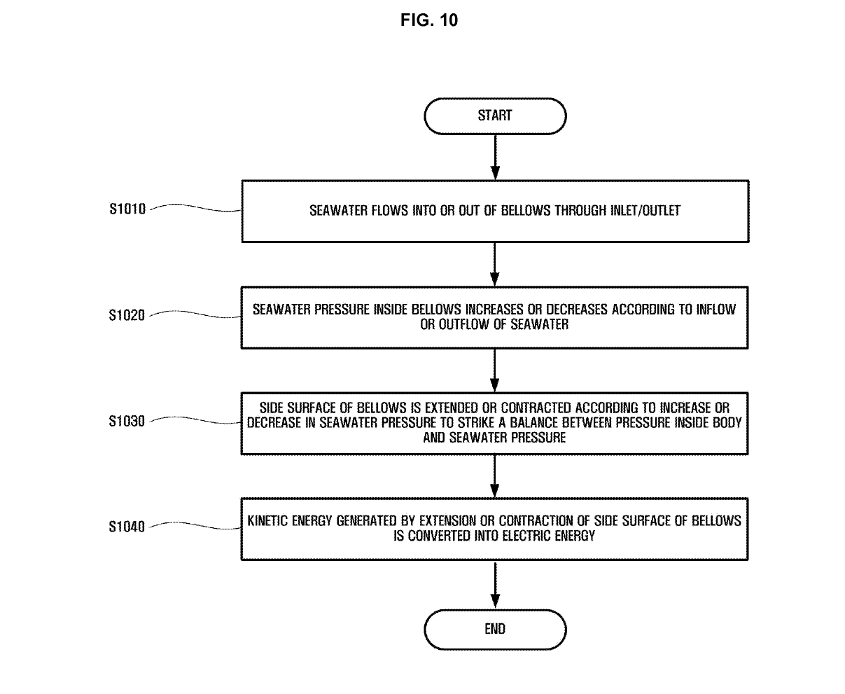

FIG. 10 is a flowchart illustrating a wave power generating method according to another embodiment of the present invention.

The wave power generating method according to the current embodiment is used by a wave power generating apparatus which includes a body 500 and a corrugated hose module 601 installed in the body 500, wherein seawater flows into or out of an internal space of the corrugated hose module 601. Specifically, seawater flows into or out of the corrugated hose module 601 through a seawater inlet/outlet 610 formed at a lower end of the corrugated hose module 601 (operation S1010), and the seawater pressure inside the corrugated hose module 601 is increased or decreased by the inflow or outflow of the seawater (operation S1020). The increased or decreased seawater pressure extends or contracts a side surface of the corrugated hose module 601 to strike a balance between the pressure inside the body 500 and the seawater pressure (operation S1030). Kinetic energy generated by the extension or contraction of the side surface of the corrugated hose module 601 is converted into electric energy, thereby generating electricity.

The corrugated hose module 601 corresponds to the driving assembly 600 of FIG. 4 which is shaped like a corrugated hose. That is, the driving assembly 600 shaped as shown in FIG. 5 is the corrugated hose module 601.

More specifically, as a wave height 3 increases, the water pressure outside the body 500 increases. Accordingly, seawater flows into the corrugated hose module 601 through the seawater inlet/outlet 610 (operation S1010), thus increasing the water pressure inside the corrugated hose module 601 (operation S1020). The increased water pressure extends the corrugated hose module 601 (operation S1030).

Conversely, as the wave height 3 decreases, the water pressure outside the body 500 decreases. Accordingly, seawater flows out of the corrugated hose module 601 through the seawater inlet/outlet 610 (operation S1010), thus reducing the water pressure inside the corrugated hose module 601 (operation S1020). The reduced water pressure contracts the corrugated hose module 601 (operation S1030).

The repeated extension and contraction of the corrugated hose module 601 generates kinetic energy, and the generated kinetic energy rotates a motor and the like. Accordingly, the kinetic energy is converted into electric energy, thereby generating electricity (operation S1040).

The present invention uses the wave power generating apparatus 10 or 50 which is easy to install and maintain. The present invention is an environment-friendly new renewable energy production technology that does not require fuel consumption and does not produce pollutants.

A wave power generating apparatus according to the present invention is made to float underwater or fixed to a seabed. Since the apparatus is not directly exposed on the surface of the ocean, it can be protected from marine disasters such as high seas, typhoons, and tsunami.

In addition, a component corresponding to a lid of a conventional wave power generating apparatus is placed on a bottom surface of a body of the wave power generating apparatus according to the present invention. Thus, a weight can be placed on the component to offset atmospheric pressure and seawater pressure. Accordingly, a large change can be induced in the internal volume of the wave power generating apparatus with respect to the change in wave height while the pressure inside the wave power generating apparatus is maintained relatively low, and the change in the amplitude of a rotor of the wave power generating apparatus with respect to the amplitude of the wave height can be increased. Therefore, the wave power generating apparatus according to the present invention is more efficient in power generation than the conventional wave power generating apparatus. In this regard, the wave power generating apparatus according to the present invention can be installed in waters having a low wave height, like Korean waters.

The wave power generating apparatus according to the present invention is easy to maintain since internal structures can be completely protected from seawater by a bellows, etc. made of a waterproof material and can float underwater since seawater pressure acts on the body of the wave power generating apparatus in a vertically upward direction. In addition, since the body can be easily fixed to the seabed using, e.g., a rope, the installation cost can be reduced.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

What is claimed is:

1. A wave power generating apparatus comprising:
a housing;
a bellows shaped like a corrugated hose having an open end, disposed in the housing, and extended or contracted by an external force;
a weight disposed on the bellows;
a rotor disposed on the weight and moving according to the extension or contraction of the bellows and the movement of the weight; and
a generator converting kinetic energy of the rotor into electric energy.

2. The apparatus of claim 1, wherein the bellows comprises a cavity therein and is extended or contracted by seawater flowing into or out of the cavity through the open end.

3. The apparatus of claim 1, further comprising:
a plurality of linear guide shafts fixed to both inner sides of the housing; and
a linear guide block connected to the weight and moving along the linear guide shafts.

4. The apparatus of claim 3, further comprising a plurality of shaft supports fixing each of the linear guide shafts to an inside of the housing.

5. The apparatus of claim 1, further comprising a flange connecting the open end of the bellows to the housing.

6. The apparatus of claim 1, further comprising:
a first support installed on a seabed and fixed to the seabed; and
a rope connecting the first support and the housing.

7. The apparatus of claim 1, further comprising a second support which is installed on the seabed to support the housing and comprises a seawater induction passage through which the seawater flows.

8. The apparatus of claim 1, wherein the rotor is formed as a permanent magnet, and the generator comprises a coil therein.

9. A wave power generating apparatus comprising:
a body in which various assemblies for wave power generation are installed;
a driving assembly disposed in the body, comprising an internal space which has an open end and a closed end, and extended or contracted by the inflow or outflow of seawater into or from the internal space;
a guide assembly connected to an upper end of the driving assembly, moving according to the extension or contraction of the driving assembly, and controlling a balance between pressure inside the body and seawater pressure inside the driving assembly; and
a generating assembly converting kinetic energy generated by the movement of the guide assembly into electric energy.

10. The apparatus of claim 9, wherein the driving assembly further comprises a driving piston which is moved up or down by the inflow or outflow of the seawater.

11. The apparatus of claim 9, wherein the driving assembly is shaped like a corrugated hose and is made of a waterproof material that prevents the seawater flowing into or out of the internal space of the driving assembly from permeating into the body.

12. The apparatus of claim 9, wherein the guide assembly comprises:
a weight controlling the balance between the pressure inside the body and the seawater pressure inside the driving assembly;
a plurality of guide shafts, each fixed to upper and lower ends of the body;
a pair of shaft supports connecting and fixing both ends of each of the guide shafts to the body; and
a guide block connected to the weight and moving along the guide shafts.

13. The apparatus of claim 12, wherein the weight moves according to the movement of the guide block.

14. The apparatus of claim 12, wherein the sum of the pressure inside the body and the weight of the weight balances the seawater pressure.

15. The apparatus of claim 9, wherein the generating assembly comprises:
a rotor connected to an upper end of the guide assembly, moving according to the movement of the guide assembly, and comprising a coil; and
a stator comprising an internal space, in which the rotor moves, and N- and S-pole magnets arranged alternately,
wherein the movement of the rotor generates an induced electromotive force in the coil of the rotor.

16. The apparatus of claim 9, wherein the generating assembly comprises:
a generating piston connected to the upper end of the guide assembly and making an up-and-down motion according to the movement of the guide assembly;
a hydraulic cylinder containing a fluid which is circulated by the up-and-down motion of the generating piston; and
a hydraulic generator generating electricity when a motor is rotated by the circulation of the fluid of the hydraulic cylinder.

17. The apparatus of claim 16, wherein the hydraulic cylinder comprises a pipe through which the fluid in the hydraulic cylinder is circulated via the hydraulic generator and a check value which allows the fluid to flow in only one direction.

18. The apparatus of claim 9, further comprising a fixing assembly fixing the body to a seabed such that the body floats underwater within a predetermined range.

19. The apparatus of claim 18, wherein the fixing assembly comprises:
a support installed on the seabed; and
a connector connecting the support and the body.

20. A wave power generating method used by a wave power generating apparatus which comprises a housing, a bellows installed in the housing and shaped like a corrugated hose, a weight disposed on the bellows, a rotor disposed on the weight and making an up-and-down motion, and a generator converting kinetic energy of the rotor into electric energy, the method comprising:
seawater flowing into or out of the bellows through an open end of the bellows;
the bellows being extended or contracted by the inflow or outflow of the seawater;
the weight ascending or descending according to the extension or contraction of the bellows;
the rotor ascending or descending according to the ascending or descending of the weight; and
the generator generating electricity as the rotor ascends or descends.
